(19) United States
(12) Patent Application Publication
(10) Pub. No.: US 2025/0012495 A1
(43) Pub. Date: Jan. 9, 2025

(54) ACCUMULATOR FOR AN AIR CONDITIONING CIRCUIT

(71) Applicant: Hutchinson Fluid Management Systems, Inc., Auburn Hills, MI (US)

(72) Inventors: Manoj BILLA, Farmington Hills, MI (US); Daniel BLONDELL, St Clair Shores, MI (US); John FISK, Edon, OH (US)

(21) Appl. No.: 18/765,504

(22) Filed: Jul. 8, 2024

(30) Foreign Application Priority Data
Jul. 7, 2023 (FR) 2307250

(51) Int. Cl. F25B 43/00; B01D 45/08; B01D 50/20

(52) U.S. Cl. CPC F25B 43/006; B01D 45/08; B01D 50/20; F25B 2400/23

(57) ABSTRACT

An accumulator including an enclosure extending around and along a first axis, an inlet port for a refrigerating fluid, and an outlet port for a refrigerating gas, a suction tube for the refrigerating gas, and a deflector mounted in the enclosure, the deflector including a deflector wall having a generally inverted bowl or bell shape centred on a second axis parallel to the first axis and defining at least one first internal cavity in which the inlet of the suction tube is located, the deflector wall further having a first passage for the suction tube, the deflector further including a filtration wall closing the first internal cavity and having a second passage for the suction tube.

### TECHNICAL FIELD OF THE INVENTION

The invention relates to the field of the accumulators for the air conditioning circuits, in particular for motor vehicles.

The invention relates in particular to the field of accumulators equipped with a deflector.

### TECHNICAL BACKGROUND

The prior art is illustrated by documents JP-A-2019066137, US-B1-U.S. Pat. No. 6,167,720 and EP-A1-0825399.

The motor vehicles are typically equipped with an air conditioning circuit allowing to cool the passenger compartment of the vehicle.

The air conditioning circuits are closed circuits for the circulation of a refrigerant. An air conditioning circuit typically comprises a compressor, a condenser or a cooler, an evaporator and an accumulator mounted between the evaporator and the compressor. The compressor is connected to the condenser by a high pressure circuit and the evaporator is connected to the compressor by a low pressure circuit.

The refrigerant is initially in a gaseous state and is compressed in the compressor and then discharged towards the condenser through the high pressure circuit. The refrigerant then changes from a gaseous state to a liquid state in the condenser and is conveyed in a liquid state to the evaporator. In the evaporator, the refrigerant is converted from a liquid state to a gaseous state before being conveyed to the compressor through the low pressure circuit.

The primary function of the accumulator is to separate the liquid and gaseous phases of the refrigerant and to accumulate the liquid phase of this refrigerant to prevent its return to the compressor.

The document US-B1-U.S. Pat. No. 6,481,241 describes an accumulator comprising a cylindrical enclosure extending along a first axis between a closed lower end and an upper end closed by a lid. The accumulator further comprises an inlet port for the refrigerating fluid connected to the evaporator and an outlet port for the gas connected to the compressor. The inlet and outlet ports are typically located on the lid of the accumulator.

The accumulator further comprises a gas suction tube arranged in the enclosure and having a gas inlet located in the enclosure and a gas outlet connected to the outlet port.

In order to allow the separation of the liquid and gaseous phases of the refrigerating liquid, the accumulator further comprises a deflector mounted in the enclosure, between the lid and the gas inlet. The deflector has a bell-shaped deflector wall defining an internal cavity in which the gas inlet is arranged. The function of the deflector is to promote the flowing of the liquid phase along the walls of the enclosure and to protect the gas inlet from the flowing of this liquid, thus allowing the suction tube to collect only the refrigerating gas and return it to the compressor.

Although efficient, such an accumulator is not entirely satisfactory. Indeed, even if the gas inlet of the suction tube is well protected by the deflector allowing to limit the amount of liquid returned to the compressor, the gas sucked through the suction tube can still be contaminated by contaminants such as suspended particles. The accumulation of these particles can cause damage to the suction tube and even the compressor.

There is therefore a need to provide an accumulator allowing to limit the contamination of the gaseous phase of the refrigerating fluid in the suction tube.

### SUMMARY OF THE INVENTION

To this end, the invention proposes an accumulator for an air conditioning circuit, in particular of a motor vehicle, the accumulator comprising:
an enclosure extending around and along a first axis,
an inlet port for a refrigerating fluid, and
an outlet port for a refrigerating gas,
a suction tube for the refrigerating gas arranged in the enclosure and having an inlet for the refrigerating gas located in the enclosure and an outlet for the refrigerating gas connected to the outlet port and oriented towards the top of the enclosure, the inlet and the outlet each having an axis extending parallel to the first axis, and
a deflector mounted in the enclosure, the deflector comprising a deflector wall having a generally inverted bowl or bell shape centred on a second axis parallel to the first axis and defining at least one first internal cavity in which the inlet of the suction tube is located, the deflector wall further having a first passage for the suction tube.

The accumulator being remarkable in that the deflector further comprises a filtration wall closing the first internal cavity and having a second passage for the suction tube.

The filtration wall allows the refrigerating gas to be filtered as it enters the first cavity before being sucked through the suction tube. Such a filtration wall ensures that the refrigerating gas sucked through the suction tube is free of contaminants, limiting the damages within the suction tube or the compressor.

This filtration wall is integrated into the deflector, which allows to reduce the overall dimension of the accumulator.

In addition, this integration of the filtration wall with the deflector facilitates the assembly of the accumulator.

The invention may comprise one or more of the following characteristics, taken alone or in combination with each other:
the filtration wall is connected to the deflector wall,
the filtration wall comprises at least one filter and advantageously a plurality of filters,
the or each filter comprises a filter medium comprising fibres,
the filtration wall is annular and centred on the second axis, the filters being distributed around the second axis,
the filtration wall has a semi-circular shape centred on the second axis,
the deflector wall defines a second internal cavity adjacent to the first internal cavity, this second internal cavity being intended to receive a dehydrating bag,
the deflector wall has orifices opening out into the second internal cavity,
the deflector comprises an axial partition passing through the second axis and separating the first and second internal cavities,
the deflector comprises ribs connected to the deflector wall and extending radially from a longitudinal axis parallel to the first axis,
the deflector comprises fins regularly distributed around the second axis,
the fins are arranged on an external periphery of the deflector wall and rest on the enclosure,
the suction tube is J-shaped or U-shaped,
the suction tube comprises an internal conduit on which the outlet for the refrigerating gas is provided and an external conduit on which the inlet for the refrigerating gas is provided, the external conduit being arranged coaxially around the internal conduit,
the second axis is aligned with the first axis, or is offset from the first axis,
the accumulator comprises a lid attached to an upper end of the enclosure, the outlet port being provided in the lid and the deflector being connected to the lid,
the deflector comprises a sleeve extending coaxially around the suction tube and connected to the lid,
the sleeve extends axially into the first passage,
the deflector comprises blades located on an upper annular portion of the deflector wall,
the enclosure extends between an upper end and a lower end, the inlet and/or outlet port being located on the upper end of the enclosure,
the accumulator comprises a lid attached to the upper end of the enclosure, the outlet port and optionally the inlet port being provided in the lid,
the lid is assembled with the suction tube and the deflector. This allows to make it easier to assemble the accumulator,
the deflector wall is inverted U-shaped in longitudinal section.

The invention also relates to air conditioning circuit, in particular for a motor vehicle. The air conditioning circuit being remarkable in that it comprises an accumulator according to any of the preceding features.

### BRIEF DESCRIPTION OF THE FIGURES

Further characteristics and advantages will be apparent from the following description of non-limiting embodiments of the invention with reference to the accompanying drawings in which:

FIG. 1 is a schematic representation of an air conditioning circuit for a motor vehicle,

FIG. 2 is a longitudinal cross sectional view of an accumulator according to a first embodiment of the invention,

FIG. 3 is a longitudinal cross sectional view of a suction tube according to an alternative embodiment,

FIG. 4 is a perspective view from below of the deflector connected to the lid, which can be fitted to the accumulator of FIG. 2,

FIG. 5 is a longitudinal cross sectional view of an accumulator according to a second embodiment of the invention,

FIG. 6 is a perspective view from below of the deflector connected to the lid, equipping the accumulator in FIG. 5,

FIG. 7 is a longitudinal cross sectional view of an accumulator according to a third embodiment of the invention,

FIG. 8 is a perspective view from below of the deflector connected to the lid, equipping the accumulator of FIG. 7,

FIG. 9 is a longitudinal cross sectional view of an accumulator according to a fourth embodiment of the invention,

FIG. 10 is a perspective view from below of the deflector connected to the lid, equipping the accumulator of FIG. 9.

### DETAILED DESCRIPTION OF THE INVENTION

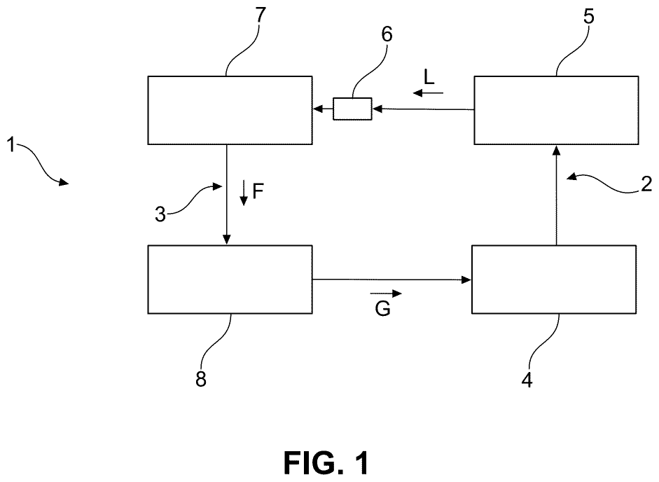

FIG. 1 shows an example of an air conditioning circuit 1. The air conditioning circuit 1 is in particular for a vehicle, for example a car or an aircraft. The air conditioning circuit 1 can be implemented in any type of installation requiring an air conditioning circuit.

The air conditioning circuit 1 is a closed circuit comprising a high pressure circuit 2 and a low pressure circuit 3. The air conditioning circuit 1 furthermore comprises a compressor 4, a condenser 5, possibly an expansion valve 6, an evaporator 7 and an accumulator 8 mounted between the evaporator 7 and the compressor 4.

The compressor 4 is connected to the condenser via the high pressure circuit 2 and the accumulator 8 is connected to the evaporator 7 and to the compressor 4 via the low pressure circuit 3.

A refrigerating gas G is compressed within the compressor 4 and discharged towards the condenser 5 through the high pressure circuit 2. The refrigerating gas G is then condensed in the condenser 5 to form a refrigerating liquid L. The refrigerating liquid L from the condensation of the refrigerating gas G is expanded in the expansion valve 6 and conveyed to the evaporator 7. In the evaporator 7, the refrigerating liquid L is partly evaporated and a refrigerating fluid F comprising a mixture of refrigerating gas G and refrigerating liquid L is conveyed to the accumulator 8. In the accumulator 8, the refrigerating liquid L is separated from the refrigerating gas G and the refrigerating gas G is returned to the compressor 4 through the low-pressure circuit 3 while the refrigerating liquid L is accumulated in the accumulator 8.

The refrigerating gas G is preferably a carbon dioxide, in particular the gas R744.

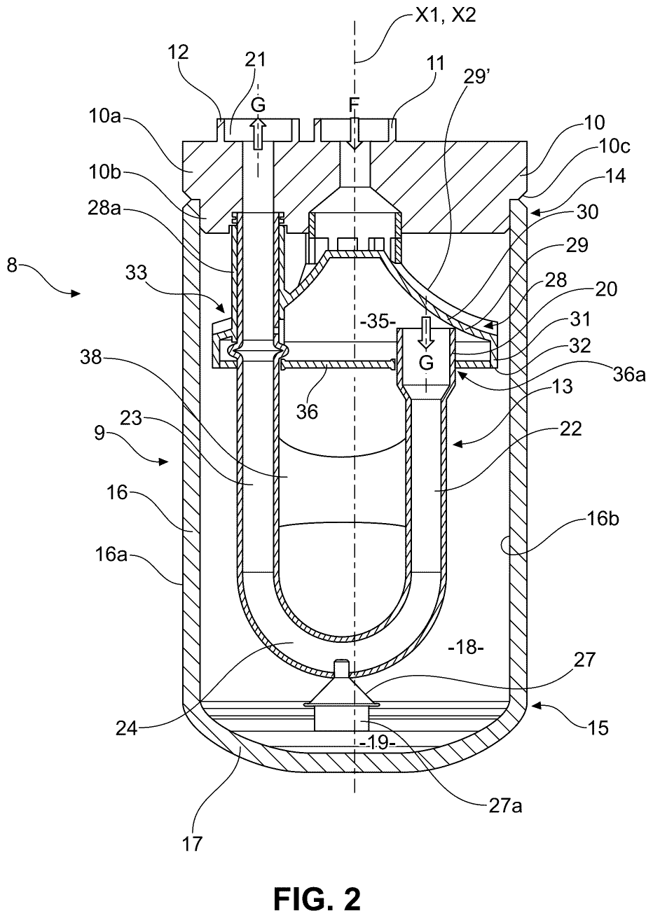

With reference, for example, to FIG. 2 illustrating a first embodiment of the accumulator 8 according to the invention, it comprises an enclosure 9, advantageously a lid 10, an inlet port 11 for the refrigerating fluid F, an outlet port 12 for the refrigerating gas G, and a suction tube 13.

The enclosure 9 extends around and along a first axis X1.

In the following description, the terms “lower” and “upper” are understood in relation to the orientation of circulation of the refrigerating fluid F, and in particular the refrigerating liquid L, in the enclosure 9 along the first axis X1. In FIG. 2, the liquid phase L circulates from top to bottom.

The terms “inside” and “outside” are understood to refer to the distance from the first axis X1 of the enclosure 9 along a radial axis perpendicular to the first axis X1.

The terms “longitudinal” and “longitudinally” are understood with respect to the first axis X1.

The enclosure 9 extends along the first axis X1 between an upper end 14 and a lower end 15. The enclosure 9 is preferably cylindrical. The upper and lower ends 14, 15 of the enclosure 9 are connected by a cylindrical wall 16 centred on the first axis X1. The cylindrical wall 16 has an external cylindrical face 16a and an internal cylindrical face 16b.

The lower end 15 of the enclosure 9 is closed by a bottom wall 17 opposite the upper end 14.

The enclosure 9 is hollow and comprises an internal space 18 defined by the cylindrical wall 16 and an enclosure bottom 19 defined by the bottom wall 17.

The enclosure 9 is for example made of polymeric, composite or metallic material.

The lid 10 is arranged on the upper end 14 of the enclosure 9. The lid 10 is annular and centred on the first axis X1. The lid 10 closes the upper end 14 of the enclosure 9. The lid 10 is attached to the upper end 14 of the enclosure. For example, it is fixed by welding.

The lid 10 comprises an upper annular portion 10a and a lower annular portion 10b joined by a shoulder 10c. The lower annular portion 10b has a smaller diameter than the diameter of the upper annular portion 10a. The lower annular portion 10b extends into the internal space 18 of the enclosure 9, and the shoulder 10c abuts the upper end 14 of the enclosure 9. Such a configuration of the lid 10 allows to ensure that the enclosure 9 is sealed.

The inlet and outlet ports 11, 12 are advantageously arranged in the lid 10. The inlet and outlet ports 11, 12 are advantageously axial. They therefore each have an axis extending parallel to the first axis X1. The axis of the inlet or outlet port 11, 12 may be aligned or offset from the first axis X1.

In the embodiment shown in FIG. 2, the axis of the inlet port 11 is aligned with the first axis X1 and the axis of the outlet port 12 is offset from the first axis X1.

The inlet port 11 opens out into the enclosure 9 and thus into the internal space 18. It is connected to the evaporator 7 via the low pressure circuit 3.

The outlet port 12 is connected to the compressor 4 via the low pressure circuit 3.

The suction tube 13 is located in the enclosure 9, i.e. in the internal space 18 of the enclosure 9. The suction tube 13 comprises an inlet 20 of the gas G and an outlet 21 of the refrigerating gas G connected to the outlet port 12 of the accumulator 8. Preferably, the outlet 21 of the suction tube 13 extends into the outlet port 12. The outlet port 12 and the outlet 21 of the suction tube 13 are coaxial. The outlet 21 thus has an axis parallel to the first axis X1. The outlet 21 for the refrigerating gas G is oriented towards the top of the enclosure 9.

The gas inlet 20 of the suction tube 13 is located in the enclosure 9, i.e. in the internal space 18. The gas inlet 20 is advantageously axial and thus has an axis extending parallel to the first axis X1. Advantageously, the inlet 20 has a flared shape towards the upper end 14 of the enclosure 9. This allows the gas G to flow through the suction tube 13.

In the embodiment shown in FIG. 2, the suction tube 13 is U-shaped or J-shaped. In this embodiment, the suction tube 13 comprises a first conduit 22 connected to the inlet 20, a second conduit 23 connected to the outlet 21 and an elbow 24 connecting the first and second conduits 22, 23 together. The first and second conduits 22, 23 and the elbow 24 have an internal diameter that is smaller than the internal diameters of the inlets and outlets 20, 21 of the suction tube 13, for example.

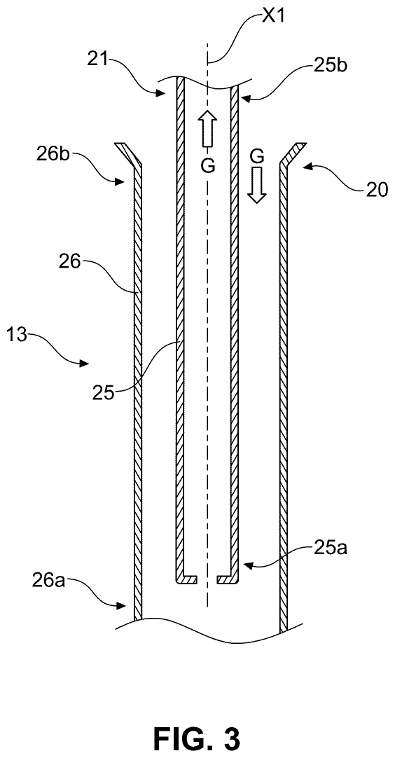

According to an alternative embodiment of the suction tube 13 shown in FIG. 3, the suction tube 13 is of the coaxial type. It comprises an internal conduit 25 advantageously centred on the first axis X1 and an external conduit 26 arranged coaxially around the internal conduit 25.

The external conduit 26 extends axially between a lower end 26a and an upper end 26b. The upper end 26b is located axially between the lid 10 and the lower end 15 of the enclosure 9. The inlet 20 is located on the external conduit 26 at the level of its upper end 26b.

The internal conduit 25 extends axially between a lower axial end 25a and an upper axial end 25b through the outlet port 11. The lower and upper axial ends 25a, 25b of the internal conduit 25 are open so as to allow the entry and the exit of the refrigerating gas G. The outlet 21 is provided on the external conduit 26, in particular at the level of its upper axial end 25b.

Suspended oil particles may be mixed with the refrigerating gas G. To this end, the suction tube 13 may comprise an orifice 13a for oil recovery and circulation into the suction tube. The orifice 13a is provided in the elbow 24 or in the lower end 26a of the external conduit 26.

In addition, the accumulator 8 advantageously comprises an oil filtration device 27 connected to the suction tube 13 and to the compressor 4. The filtration device 27 is located in the internal space 18 of the enclosure 9 opposite the first end 14 of the enclosure 9. The filtration device 27 is connected to the suction tube 13 by an attachment means such as a clamp or by screwing.

The filtration device 27 comprises an oil filter 27a allowing to filter the oil before it is circulated through the suction tube 13. The oil present in the bottom of the enclosure 19 and mixed with the refrigerant liquid L is thus drawn in by the refrigerant gas G circulating into the suction tube G via the orifice 13a to be returned to the compressor 4.

This maintains optimum lubrication of the refrigerant gas G.

The accumulator 8 further comprises a deflector 28. The deflector 28 is mounted in the enclosure 8, i.e. in the internal space 18. The deflector 28 is arranged axially between the lid 10 and the inlet 20 for the refrigerating gas G of the suction tube 20. The deflector 28 allows the flowing of the refrigerating fluid F to be diverted towards the internal face 16b of the cylindrical wall 16 of the enclosure 9. This allows to protect the gas inlet 20 of the suction tube 13 from the liquid phase to prevent the return of this liquid phase into the compressor 4. The deflector 28 thus promotes the separation of the liquid and gaseous phases of the refrigerating fluid F.

The deflector 28 is shaped like an inverted bowl, a bell, or a dome centred on a second axis X2. The deflector 28 thus has a general inverted U shape in longitudinal cross-section.

The second axis X2 is parallel to the first axis X1. The second axis X2 can be offset from the first axis X1 or aligned with the first axis X1 as shown in FIG. 2 for example.

The alignment of the first and second axes X1, X2 promotes uniform flow of the refrigerating fluid F around the deflector 2.

The deflector 28 comprises a deflector wall 29. The deflector wall 29 is shaped like an inverted U, an inverted bowl, a bell, or a dome centred on the second axis X2. The deflector wall 29 is for example made of metallic material such as stainless steel or a polymeric material.

The deflector 28 is connected to the lid 10 and to the suction tube 13. They are usually pre-assembled so as to facilitate the assembly and the maintenance of the accumulator 8.

The deflector wall 29 comprises an upper annular portion 30 centred on the second axis X2 and a lower annular portion 31 extending around and along the second axis X2 towards the lower end 15 of the enclosure 9 from the upper annular portion 30.

The upper annular portion 30 may be frustoconical as shown in FIG. 2 or circular. The upper annular portion 30 is attached to the lid 10.

In this embodiment, the deflector wall 29 has blades 29′ evenly distributed around the second axis X2. The blades 29′ are located, for example, on the upper annular portion 30 of the deflecting wall 29. They promote the separation of the gaseous and liquid phases of the refrigerant fluid F in the enclosure 9. The blades 29′ may extend as far as the lower annular portion 31. Preferably, the blades 29′ extend spirally over the deflecting wall 29.

The lower annular portion 31 has an annular lower end 32 centred on the second axis X2.

In the embodiment shown in FIG. 2, the lower annular portion 31 rests on the internal face 16b of the enclosure 9.

The deflector 28 advantageously comprises a sleeve 28a extending coaxially around the suction tube 13 and connected to the cover 10. The sleeve 28a extends axially into the first passage 33.

The deflector 28 advantageously comprises a first passage 33 of the suction tube 13. The first passage 33 is axially aligned with the outlet port 12. The first passage 33 can thus be centred on the second axis X2, in particular when the suction tube 13 is of the coaxial type or axially offset with respect to the second axis X2 as illustrated in FIG. 2. The first passage 33 is provided in the upper portion 33 of the deflector wall 29.

The deflector 28 further comprises at least one first internal cavity 35 in which the gas inlet 20 is located. The first internal cavity 35 is delimited by the deflector wall 29.

According to the invention, the deflector 28 further comprises a filtration wall 36 which closes the first internal cavity 35.

The filtration wall 36 is connected to the deflector wall 29 of the deflector 28. This characteristic reduces the overall dimension of the accumulator 8, as the filtration wall 36 is directly integrated into the deflector 28.

In particular, the filtration wall 36 is connected to the lower portion 31 of this deflector wall 29. In yet another example, the filtration wall 36 is attached to the lower end 32 of the lower portion 31 of the deflector 28.

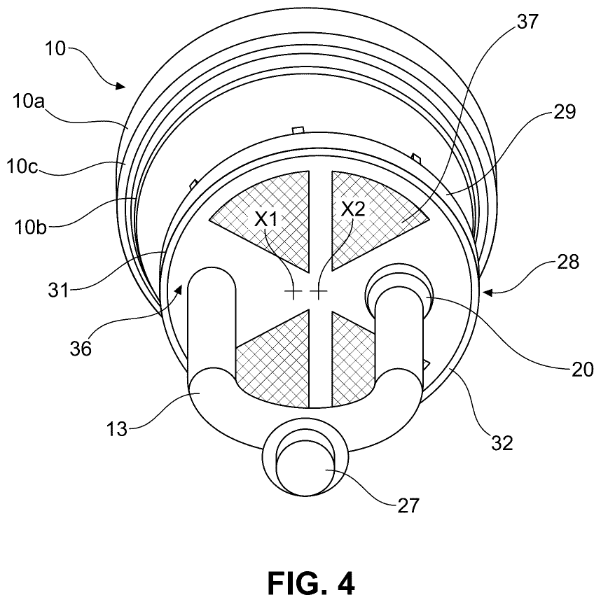

As best seen in FIG. 4, the filtration wall 36 comprises at least one filter 37 and advantageously a plurality of filters 37. Advantageously, the filtration wall 36 comprises between one and ten filters 37, preferably between four and six filters 37.

Each filter 37 comprises a filter medium. Each filter medium comprises fibres and optionally a matrix in which the fibres are embedded. The fibres are, for example, selected from metal, carbon, polyester, polyamide, glass fibres or a mixture thereof. The fibres have a diameter of between 0.01 mm and 1 mm and a length of, for example, between 0.1 mm and 10 mm. For example, the fibres are thermally bonded or braided or woven.

The matrix is for example a polymeric matrix selected from polyolefins such as a polyethylene or a polypropylene, polyamides, fluorinated polymers.

Each filter 37 is gas permeable. Each filter 37 thus has pores with a size of, for example, between 0.1 μm and 100 μm, preferably between 80 μm and 100 μm.

Each filter 37 has a substantially polygonal shape, for example triangular or trapezoidal. In the embodiment shown in FIG. 2, each filter 37 has a triangular shape.

In this embodiment, the filtration wall 36 is annular and centred on the second axis X2. According to this embodiment, the filters 37 are distributed around the second axis X2 and are in particular four in number.

The filtration wall 36 is flat.

The filtration wall 36 further comprises a second passage 36a of the suction tube 13 to allow the gas inlet 20 of the suction tube 13 to pass into the internal cavity 35.

The filtration wall 36 is thus gas permeable so as to allow the refrigerating gas G to pass through the suction tube 13 while filtering out the contaminants such as contaminating particles. The refrigerating gas G sucked through the suction tube 13 is thus free of contaminants limiting damage to the suction tube 13 or to the compressor 4.

In order to further limit the return of the liquid phase of the refrigerating fluid to the compressor 4, the accumulator 8 further comprises a dehydrating bag 38 connected to the suction tube 13. The dehydrating bag 38 comprises for example a container 38a and a dehydrating material arranged in the container 38a.

The container 38a is connected to the suction tube 13 by an attachment means 38b such as a clamp. The container 38a may be connected to the elbow 24 or to the second conduit 23 of the suction tube 13 for example or to the external conduit 26 of the suction tube 13. The container 38a can also be located between the first and second conduits 22, 23.

The dehydrating material comprises for example a gel or beads. The dehydrating material comprises, for example, silica or clay.

Preferably and not illustrated, the accumulator 8 further comprises an internal heat exchanger. The internal heat exchanger is located in the internal space 18 of the enclosure 9.

Advantageous embodiments of the accumulator 8 will now be described. Only the differences are described for each of the following embodiments. Unless otherwise stated, the entire description of the embodiment in FIG. 2 applies.

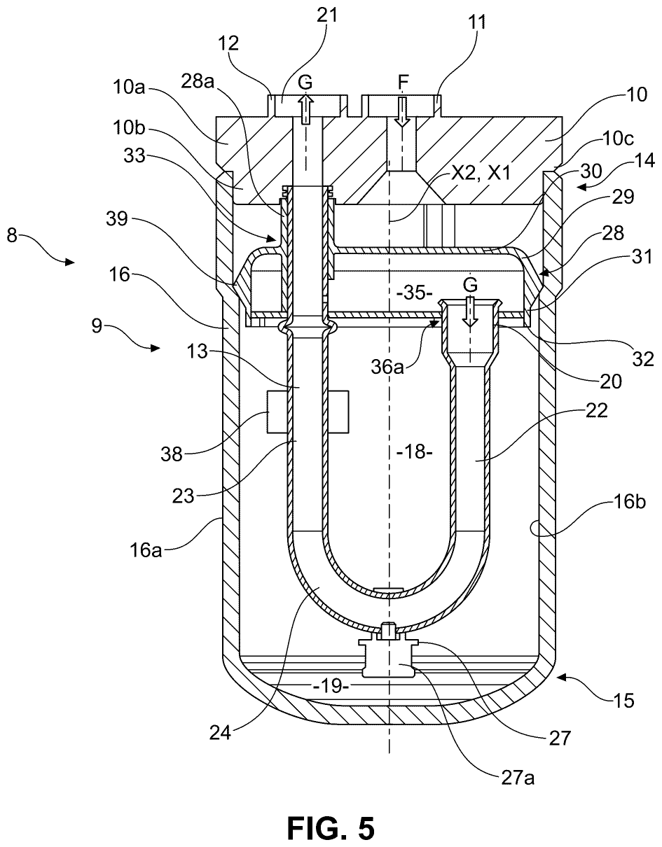

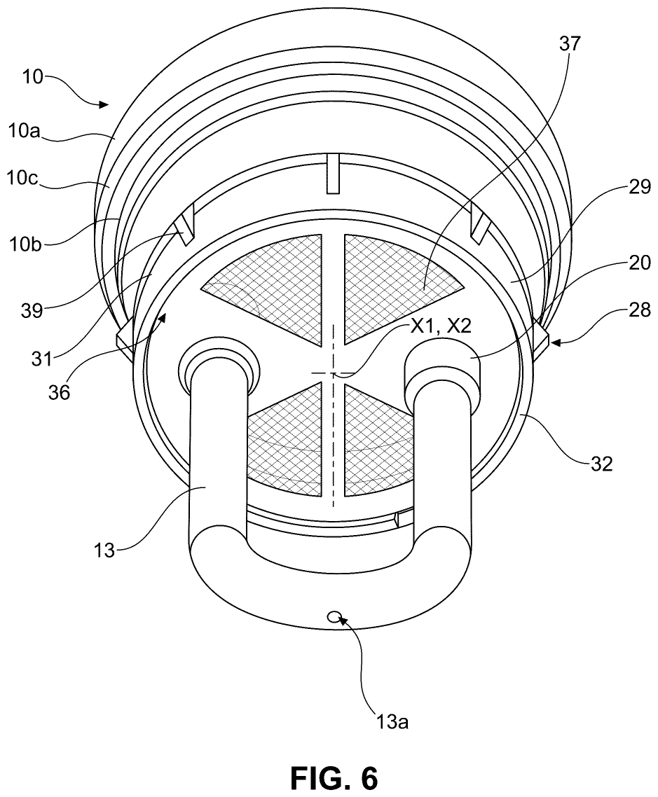

FIGS. 5 and 6 illustrate a second embodiment of the accumulator 8. In this embodiment, the deflector 28 is centred on the first axis X1.

According to this second embodiment, the deflector 28 further comprises fins 39 evenly distributed around the second axis X2. The fins 39 are located on an external periphery of the deflector wall 29, in particular on the lower portion 31 of the deflector wall 29. The fins 39 rest on the enclosure 9. The fins 39 extend radially from this deflector wall 29, for example, and cooperate in a sealing manner with the cylindrical wall 16 of the enclosure 9. The fins 39 are for example substantially triangular in shape.

The refrigerating fluid F can flow between the fins 39. The fins 39 thus allows to slow down the flowing of the refrigerating fluid F in the enclosure 9 in order to promote the separation of the liquid and gaseous phases of this refrigerating fluid F.

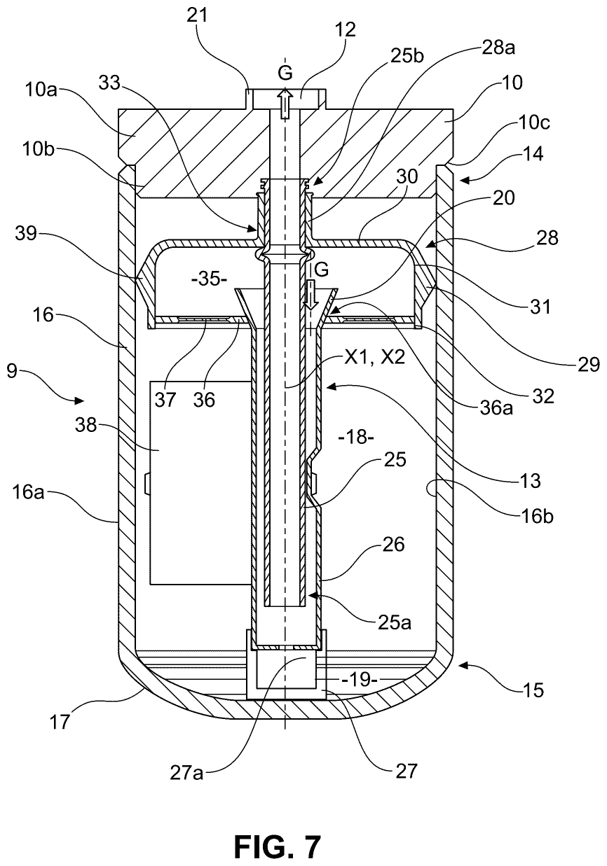

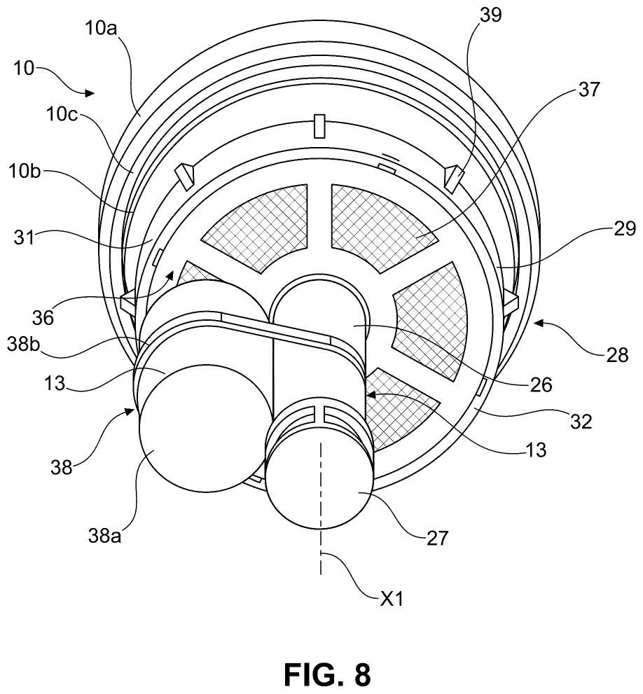

FIGS. 7 and 8 illustrate a third embodiment which is an alternative embodiment of the embodiment of FIGS. 5 and 6. In this variant, the suction tube 13 is of the coaxial type as described with reference to FIG. 3.

According to this variant, the filters 37 are regularly distributed around the second axis X2. The filters 37 are for example six in number and have a substantially trapezoidal shape.

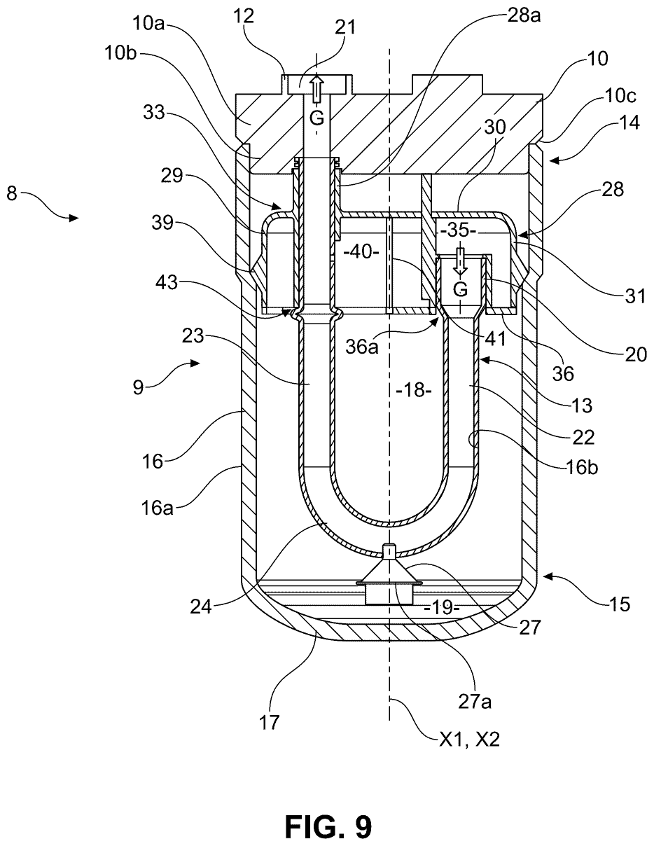

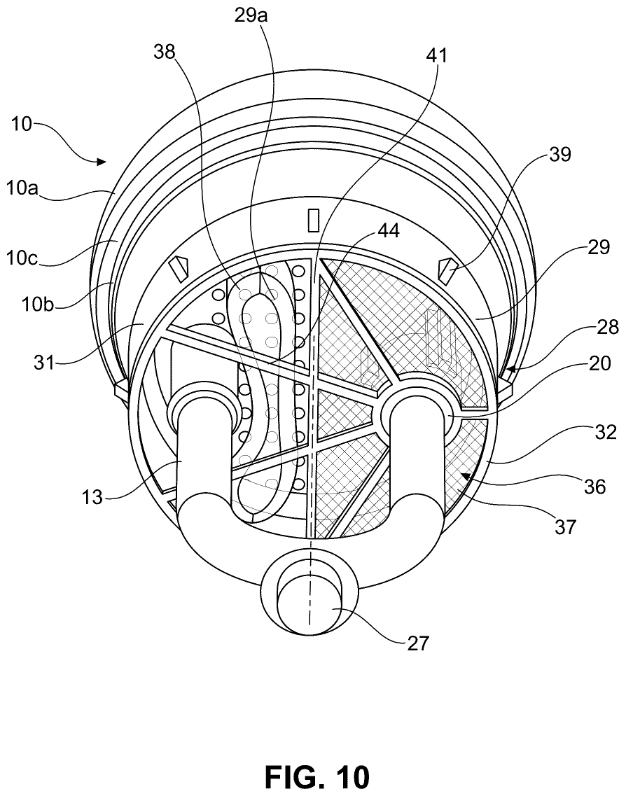

FIGS. 9 and 10 illustrate a fourth embodiment of the accumulator 8. This third embodiment differs from the second embodiment in that the deflector 28 comprises a second internal cavity 40. The dehydrating bag 38 is arranged in the second cavity 42.

The first and second internal cavities 35, 40 are adjacent. They are separated by an axial partition 41 passing through the second axis X2. The axial partition 41 extends axially from the deflector wall 29 towards the lower end 15 of the enclosure 9.

In this embodiment, the filtration wall 36 has a generally semi-circular shape centred on the second axis X2. By centred on the second axis X2, it is understood that the centre of the circle, in which the semi-circular filtration wall 36 is inscribed, passes through the second axis X2.

According to this embodiment, the deflector wall 29 has holes 29a opening out into the second cavity 40. The holes 29a are evenly distributed on the deflector wall 29. They are generally circular or elliptical in shape and have a diameter of between 0.01 mm and 1 mm.

The deflector wall 42 furthermore has a third passage 43 of the suction tube 13, in particular of the second conduit 23. The third passage 43 is axially aligned with the first passage 33.

According to this embodiment, the deflector 28 further comprises ribs 44 connected to the deflector wall 29, in particular to the lower end 32 of the deflector wall 29 and closing the second internal cavity 40. The ribs 44 extend radially with respect to a longitudinal axis parallel to the first axis X1. The ribs 44 allow to mechanically reinforce the deflector 28 and maintain the dehydrating bag into the second internal cavity 40.

The alternative embodiment shown in FIG. 3 can also be applied to this fourth embodiment.

The filtration wall 36 filters the refrigerating gas G that enters the first cavity 35 before being sucked through the suction tube 13. Thanks to such a filtration wall 36, the refrigerating gas G sucked in through the suction tube 13 is thus free of contaminants limiting damage within the suction tube 13 or the compressor 4.

This filtration wall 36 is integrated into the deflector 8, which allows to reduce the overall dimension of the accumulator 8.

1. An accumulator for an air conditioning circuit, in particular of a motor vehicle, the accumulator comprising:
an enclosure extending around and along a first axis,
an inlet port for a refrigerating fluid, and
an outlet port for a refrigerating gas,
a suction tube for the refrigerating gas arranged in the enclosure and having an inlet for the refrigerating gas located in the enclosure and an outlet for the refrigerating gas connected to the outlet port and oriented towards the top of the enclosure, the inlet and the outlet each having an axis extending parallel to the first axis, and
a deflector mounted in the enclosure, the deflector comprising a deflector wall having a generally inverted bowl or bell shape centred on a second axis parallel to the first axis and defining at least one first internal cavity in which the inlet of the suction tube is located, the deflector wall further having a first passage for the suction tube,
characterised in that the deflector further comprises a filtration wall closing the first internal cavity and having a second passage for the suction tube.

2. The accumulator according to claim 1, characterised in that the filtration wall is connected to the deflector wall.

3. The accumulator according to claim 1, characterised in that the filtration wall comprises at least one filter and advantageously a plurality of filters.

4. The accumulator according to claim 3, characterised in that the or each filter comprises a filter medium comprising fibres.

5. The accumulator according to claim 1, characterised in that the filtration wall is annular and centred on the second axis, the filters being distributed around the second axis.

6. The accumulator according to claim 1, characterised in that the filtration wall has a semi-circular shape centred on the second axis.

7. The accumulator according to claim 6, characterised in that the deflector wall defines a second internal cavity adjacent to the first internal cavity, this second internal cavity being intended to receive a dehydrating bag.

8. The accumulator according to claim 7, characterised in that the deflector wall has orifices opening out into the second internal cavity.

9. The accumulator according to claim 7, characterised in that the deflector comprises an axial partition passing through the second axis and separating the first and second internal cavities.

10. The accumulator according to claim 1, characterised in that the deflector comprises ribs connected to the deflector wall and extending radially from a longitudinal axis parallel to the first axis.

11. The accumulator according to claim 10, characterised in that the deflector comprises fins regularly distributed around the second axis.

12. The accumulator according to claim 11, characterised in that the fins are arranged on an external periphery of the deflector wall and rest on the enclosure.

13. The accumulator according to claim 1, characterised in that the suction tube is J-shaped or U-shaped.

14. The accumulator according to claim 1, characterised in that the suction tube comprises an internal conduit on which the outlet for the refrigerating gas is provided and an external conduit on which the inlet for the refrigerating gas is provided, the external conduit being arranged coaxially around the internal conduit.

15. The accumulator according to claim 1, characterised in that the second axis is aligned with the first axis, or is offset from the first axis.

16. The accumulator according to claim 1, characterized in that it comprises a lid attached to an upper end of the enclosure, the outlet port being provided in the lid and the deflector being connected to the lid.

17. The accumulator according to claim 16, characterized in that the deflector comprises a sleeve extending coaxially around the suction tube and connected to the lid.

18. The accumulator according to claim 17, characterized in that the sleeve extends axially into the first passage.

19. The accumulator according to claim 18, characterized in that the deflector comprises blades located on an upper annular portion of the deflector wall.

20. An air conditioning circuit, in particular for a motor vehicle, comprising an accumulator according to claim 1.
